(19) United States
(12) Patent Application Publication
(10) Pub. No.: US 2004/0108414 A1
(43) Pub. Date: Jun. 10, 2004

(54) Hydrant cart fuel management

(76) Inventors: Thomas G. Determan, Ham Lake, MN (US); Anthony A. Clermont, St. Francis, MN (US); Hugh I. Myers, Woodbury, MN (US); Gary L. Mason, Zimmerman, MN (US)

Correspondence Address: IPLM GROUP, P.A., POST OFFICE BOX 18455, MINNEAPOLIS, MN, 55418, US

(21) Appl. No.: 10/458,800

(22) Filed: Jun. 10, 2003

Related U.S. Application Data
(60) Provisional application No. 60/388,065, filed on Jun. 11, 2002.

(51) Int. Cl. B64D 37/00

(52) U.S. Cl. 244/135 R

(57) ABSTRACT

A fuel delivery management system (10) is utilized to transfer fuel during the fueling of aircraft. The system (10) uses only one energy type that provides a convenience start-up mode and also provides a self-contained sump pump back.

This application claims the benefit of U.S. provisional patent application Serial No. 60/388,065, filed Jun. 11, 2002, entitled “Hydrant Cart Fuel Management.”

### BACKGROUND OF THE INVENTION

1. Field of the Invention

This invention relates to the management of the fuel transfer during the fueling of aircraft. The principles may also apply to other similar applications of fluid management. In an airport application, the fluid source may be either a hydrant system or a truck tank.

The current invention provides a fuel delivery management system that uses only one energy type, that provides a convenience start up mode, and that provides a self-contained sump pump back.

2. Description of the Prior Art

The basic hydrant system to deliver fuel to an aircraft includes a pit coupler embedded in the ground, below ground level, located near the aircraft gate. The coupler is supplied with fuel via an underground piping system from a tank farm. The potential flow rate and pressure that is available at the coupler is far in excess of what the aircraft fuel tank system can accept. The aircraft fuel tank system is commonly called the manifold.

The fuel delivery management system controls this hydrant pressure and flow. This system is generally called the cart.

The pressure of the fuel at the aircraft fuel manifold is monitored via simulation so that the pressure does not exceed a primary pressure value. The pressure of the fuel at the manifold is also monitored via simulation so the pressure does not exceed a slightly higher secondary value.

The cart is connected to the pit coupler via a hydrant coupler and hose. After the hydrant coupler is attached to the pit coupler, the pit coupler receives a pressure signal from the cart to open. The signal is commonly controlled by a dead man valve.

The hydrant coupler includes a flow control valve that is modulated by the cart in response to the pressure at the aircraft manifold. This flow control valve controls the pressure at the manifold.

The fuel next passes through another flow control valve. This valve is on the cart. It also is a flow control valve that controls the pressure at manifold.

These two flow control valves provide a redundancy capability. The primary valve is set slightly lower than the secondary valve. Both are designed to fail closed if they do not receive a control signal.

One of these valves may also receive a control signal that is a function of the flow rate and can be used to control the flow rate through the cart irrespective of the pressure at the manifold. The fuel passes through a filter means and a volumetric metering means.

The primary and secondary valves require a control signal that is representative of the pressure in the aircraft manifold. A dedicated pressure measurement hose or gauge line from the aircraft is cumbersome, adds deployment time, and requires additional maintenance. Therefore, the aircraft fuel manifold pressure is simulated via a venturi mounted upstream in a convenient location, usually just ahead of the nozzle hose reel.

While fuel is flowing, the venturi pressure will be less than the static pressure at the venturi. The venturi pressure is mixed with the static pressure to create a pressure signal that is representative of the pressure at the manifold. This mixed pressure signal is commonly called the sense pressure or nozzle pressure. The sense pressure is used to modulate the primary and secondary valves.

Current fuel management systems use an auxiliary power to control the valves in the pit coupler and the cart. This power may be electric, air, or the fuel itself. In any case, energy must be stored to activate the system for start up. The storage may be a battery, an air tank, or a hydraulic accumulator.

### SUMMARY OF THE INVENTION

In one embodiment, the invention is a fuel delivery management system for management of fuel transfer during fueling of aircraft. The system has a single pressure sensor for control of fuel flow rate and for control of fueling pressure. The system includes a venturi that is placed in a fuel flow stream to create a single pressure sensing feedback signal and a primary valve is placed in the fuel flow stream and modulates the fueling pressure and the fueling flow in response from the single pressure sensing feedback signal.

In another embodiment, the invention is a fuel delivery management system for management of fuel transfer during fueling of aircraft. The system has a single pressure sensor for controlling fuel rate and for controlling fuel pressure. The system has a venturi that is placed in a fuel flow stream to create a single pressure sensing feedback signal. A primary valve is placed in the fluid flow stream. A flow control valve is placed in the fuel flow stream and modulates the fueling flow in response from the single pressure sensing feedback signal.

In another embodiment, the invention is a fuel delivery management system for management of fuel transfer during fueling of aircraft. The system has multiple sources for providing a reference pressure source during normal fuel operations. A first source is normal system fueling pressure. The second source is an accumulator that is charged from the normal system fueling of pressure. A third source is a hand pump that charges the accumulator.

In another embodiment, the invention is a fuel delivery management system for management of fuel transfer during fueling of aircraft having multiple sources for providing a start-up reference pressure source. The first source is an accumulator that is charged from normal system pressure. The second source is a hand pump that charges the accumulator.

In another embodiment, the invention is a fuel delivery management system for management of fuel transfer during fueling of aircraft having an automatic sump pump back system that uses normal system high pressure fuel to return sump fluid back into the system fluid. The system has a sump to contain accumulated or sump fuel. A pressure differential device is positioned in the system fuel flow stream that develops a pressure difference in the fuel flow stream that is less than pressure upstream of the pressure differential device. A control valve is placed in the fuel flow stream to stop flow of fuel. A pump back cylinder is utilized to collect accumulated fuel from the sump. A spring return piston in the pump back cylinder is utilized to create a suction using a spring force to pull back some of the sump fuel into the cylinder when the fuel's flow stream pressure is low and to push the sump fuel in the cylinder into the fuel flow stream downstream of the flow restriction element when the fuel flow system pressure is high.

In another embodiment, the invention is a fuel delivery management system for management of fuel transfer during fueling of aircraft having an automatic sump pump back system that uses normal system high pressure fuel to return sump fluid back into the system fluid. The management system has a sump to contain accumulated or sump fuel. A control valve is placed in the fuel stream to stop flow of fuel. A pump back cylinder is utilized to collect accumulated fuel from the sump. A spring return piston in the pump back cylinder is utilized to create a suction using a spring force to pull some of the sump fuel into the cylinder when the fuel flow pressure is low and to push the sump fuel in the cylinder into the fuel flow stream downstream of the flow restriction element when the fuel flow stream pressure is high. A piston and rod area difference is utilized such that fuel flow stream pressure acting against the piston is sufficient to overcome the spring force and fuel flow stream pressure so that the sump fuel is returned into the original fuel flow stream.

In another embodiment, the invention is a fuel delivery management system for management of fuel transfer during fueling of aircraft having a single pressure sensor for the control of fueling flow rate and for control of fueling pressure. The management system has a venturi that is placed in a fuel flow stream to create a single pressure sensing feedback signal. A primary valve is placed in the fuel flow stream and modulates the fueling pressure and the fueling flow in response from the single pressure sensing feedback signal. Multiple sources for providing a reference pressure source during normal fuel operations include a first source being normal system fueling pressure, a second source being an accumulator that is charged from the normal system fueling pressure and a third source being a hand pump that charges the accumulator. In addition, multiple sources are provided for providing a start-up reference pressure source. The multiple sources include a first source is an accumulator that is charged from the normal system fueling pressure, a second source is a hand pump that will charge the accumulator. An automatic sump pump back system uses normal system high pressure fuel to return sump fluid back into the system fluid and includes a sump to contain accumulated or sump fuel, a control valve placed in the fuel flow stream to stop flow of fuel, a pump back cylinder to collect accumulated fuel from the sump, a spring return piston in the pump back cylinder to create a suction using a spring force to pull some of the sump fuel into the sump cylinder when the fuel flow stream pressure is low and to push the sump fuel in the cylinder into the fuel flow stream downstream of the flow restriction element when the fuel flow stream pressure is high and a piston and rod area difference such that fuel flow stream pressure acting against the piston is sufficient to overcome the spring force and fuel flow stream pressure so that sump fuel is returned into the original fuel flow stream.

### BRIEF DESCRIPTION OF THE DRAWINGS

FIG. 1 is a schematic of the fuel delivery systems control cart of the present invention.

### DETAILED DESCRIPTION OF A PREFERRED EMBODIMENT

Referring to the drawing, there is generally disclosed at 10 a fuel delivery management system or cart 10. This invention uses only the fuel itself as the power source so that batteries, alternators, wiring, air tanks, compressors, etc., are not needed.

The hydrant coupler 11 includes a secondary valve 11a which includes the dead man function. The primary valve is downstream of the secondary valve, but their respective position could be interchanged.

The hydrant coupler or secondary valve has a fixed bias spring (not shown) which will close the valve 11a if there are no control pressures. The valve 11a will open if a reference pressure is present to overcome the bias. This invention can supply a start up source for the reference pressure in two ways. First, an accumulator 12 that is charged during normal fueling can provide the start up pressure source. Second, a small hand pump 13 can charge the accumulator 12 and thus supply the start up pressure source.

During normal fueling, the normal fueling pressure in the system will charge the accumulator 12 in preparation for the next start up.

In this invention, the primary valve sense pressure, the secondary valve sense pressure, and the flow control all receive their feedback signal from the same source. This source is the venturi 14 that is placed in the fuel flow stream. The static pressure is mixed via a needle valve, 24 or 25, with the venturi pressure to simulate the manifold pressure. This pressure is used to first modulate the primary valve 15 and then, in the event of failure of the primary system, to modulate the secondary valve 11a.

The venturi pressure and the system static pressure together are a measure of the flow rate through the system. This pressure relationship is used to modulate the primary valve 15 to control the flow rate.

During normal fueling, the valves 11a, 15 and other devices on the cart will discharge fluid into a sump 16, normally called a sterile tank. This sump fluid must be disposed of. Current control device systems require that the sump be emptied manually on a daily or weekly bass or the sump fluid is pumped back into the main flow of fuel by a pump that is powered by one of the auxiliary power sources, electric or air.

This invention has a pump back system that uses the normal system high pressure fuel and the pressure difference across the primary valve 15 to pump the sump fluid back into the system fluid itself. Whenever the secondary valve 11a stops the flow of fuel, a spring return piston 17 pulls sump fluid into a pump back cylinder 17a. When the secondary valve 11a is opened and fuel is flowing, the primary control valve meters the flow, thereby creating a lower pressure downstream of the valve. The higher pressure inlet fluid pushes the cylinder piston 17b thereby forcing the sump fluid into the lower pressure flow that is downstream of the primary valve 15. The pump back piston is reset the next time the secondary valve 11a is closed.

This pump back system has an additional advantage in that, if the sump 16 does not have enough fluid in it to fill the pump back cylinder 17a and air is sucked into the piston 17b, the cylinder 17a is not damaged. The air is expelled through the existing air purge mechanism on the filter vessel 8. The pump back operation is transparent to the operator.

Alternately, the pump back system can be arranged to use the area difference of the piston side and the rod side of the pump back cylinder to create a pressure difference that will push the sump fluid into the main high pressure fluid stream.

The filter vessel 18 includes an air eliminator 18a and a relief valve 18b. The flow of the fuel goes into the hydrant coupler 11a, through the primary valve 15, the filter vessel 18 and out the exit of the venturi 14 to the nozzle 19, connection of which is not shown. The sump 16 includes a vent 16a.

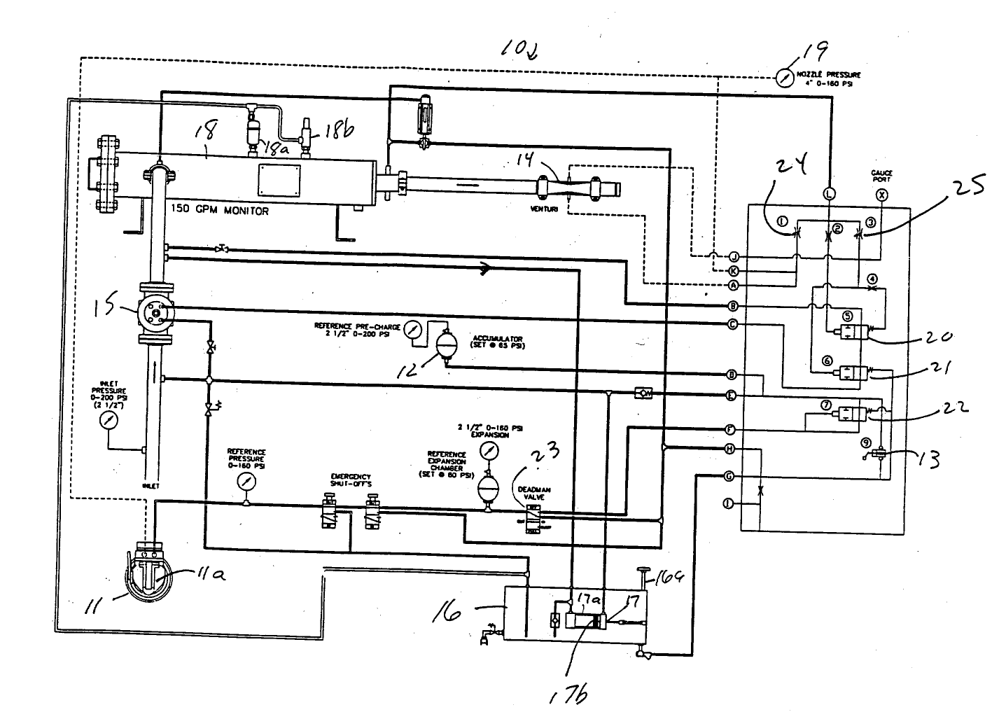

The cart 10 utilizes three valve spools 20, 21, 22. The dead man valve 23 is in fluid communication with the valve spool 22. The valves 20-22 are also in fluid communication with the components as shown in the schematic of FIG. 1.

The present invention provides for two separate means for providing a start up reference pressure source. The first is an accumulator 12 that is charged by normal fuel system pressure during fueling or by a hand pump 13 after fueling and the accumulator 12 is discharged. The present invention also provides for three independent means for providing the reference pressure source during normal fuel operations. The first is the normal system fueling pressure. The second is an accumulator that is charged by the normal system fueling pressure and the third is the hand pump.

A single pressure sensing means, the venturi, controls the primary pressure valve 15, the secondary pressure valve 11 and the flow control valve. A fluid pump back sump uses normal high system pressure, the pressure differential across the primary control valve and the normal start and stop of the fluid flow to return the sump fluid to the normal fluid flow stream.

Two independent means for providing a start up reference pressure source via an accumulator that is charged by the normal system fuel pressure during fueling or by a hand pump after fueling and the accumulator is discharged.

Three independent means for providing the reference pressure source during normal fueling operations; the normal system fueling pressure, an accumulator that is charged by the normal system fueling pressure, and a hand pump.

A single pressure sensing means, a venturi, controls the primary pressure valve, the secondary pressure valve and the flow control valve.

A fluid pump back means, a sump, uses the normal high system pressure, the pressure differential across the primary control valve, and the normal stop and start of fuel flow to return the sump fluid to the normal fluid flow stream.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A fuel delivery management system for management of fuel transfer during fueling of aircraft, the fuel delivery management system having a single pressure sensor for the control of fueling flow rate and for control of fueling pressure, comprising:
a) a venturi that is placed in a fuel flow stream to create a single pressure sensing feedback signal; and
b) a primary valve placed in the fuel flow stream modulates the fueling pressure and the fueling flow in response from the single pressure sensing feedback signal.

2. A fuel delivery management system for management of fuel transfer during fueling of aircraft, the fuel delivery management system having a single pressure sensor for the control of fueling flow rate and for control of fueling pressure, comprising:
a) a venturi that is placed in a fuel flow stream to create a single pressure sensing feedback signal;
b) a primary valve placed in the fuel flow stream;
c) a flow control valve placed in the fuel flow stream modulates the fueling flow in response from the single pressure sensing feedback signal.

3. A fuel delivery management system for management of fuel transfer during fueling of aircraft of claim 2, wherein the primary valve and the flow control valve are one valve.

4. A fuel delivery management system for management of fuel transfer during fueling of aircraft of claim 1, further comprising a secondary valve placed in the fuel flow stream modulates the fueling pressure in response from the single pressure sensing feedback signal.

5. A fuel delivery management system for management of fuel transfer during fueling of aircraft of claim 2, further comprising a secondary valve placed in the fuel flow stream modulates the fueling pressure in response from the single pressure sensing feedback signal.

6. A fuel delivery management system for management of fuel transfer during fueling of aircraft of claim 3, further comprising a secondary valve placed in the fuel flow stream modulates the fueling pressure in response from the single pressure sensing feedback signal.

7. A fuel delivery management system for management of fuel transfer during fueling of aircraft, the fuel delivery management system having multiple sources for providing a reference pressure source during normal fuel operations, comprising:
a) a first source is normal system fueling pressure;
b) a second source is an accumulator that is charged from the normal system fueling pressure; and
c) a third source is a hand pump that charges the accumulator.

8. A fuel delivery management system for management of fuel transfer during fueling of aircraft having separate multiple sources for providing a start up reference pressure source, comprising;
a) a first source is an accumulator that is charged from the normal system fueling pressure; and
b) a second source is a hand pump that charges the accumulator.

9. A fuel delivery management system for management of fuel transfer during fueling of aircraft having an automatic sump pump back system that uses normal system high pressure fuel to return sump fluid back into the system fluid, comprising:
a) a sump to contain accumulated, or sump fuel;
b) a pressure differential device in the system fuel flow stream that develops a pressure difference in the fuel flow stream that is less than pressure upstream of the pressure differential device;
c) a control valve placed in the fuel flow stream to stop flow of fuel;
d) a pump back cylinder to collect accumulated fuel from the sump; and
e) a spring return piston in the pump back cylinder to create a suction using a spring force to pull some of the sump fuel into the cylinder when the fuel flow stream pressure is low and to push the sump fuel in the cylinder into the fuel flow stream down stream of the flow restriction element when the fuel flow stream pressure is high.

10. A fuel delivery management system for management of fuel transfer during fueling of aircraft of claim 9, wherein the pressure differential device is a primary control valve.

11. A fuel delivery management system for management of fuel transfer during fueling of aircraft of claim 9, wherein the control valve is a secondary control valve.

12. A fuel delivery management system for management of fuel transfer during fueling of aircraft of claim 9, wherein the pressure differential device is a primary control valve and the control valve is a secondary control valve.

13. A fuel delivery management system for management of fuel transfer during fueling of aircraft having an automatic sump pump back system that uses normal system high pressure fuel to return sump fluid back into the system fluid, comprising:
a) a sump to contain accumulated, or sump fuel;
b) a control valve placed in the fuel flow stream to stop flow of fuel;
c) a pump back cylinder to collect accumulated fuel from the sump;
d) a spring return piston in the pump back cylinder to create a suction using a spring force to pull some of the sump fuel into the cylinder when the fuel flow stream pressure is low and to push the sump fuel in the cylinder into the fuel flow stream down stream of the flow restriction element when the fuel flow stream pressure is high; and
e) a piston and rod area difference such that fuel flow stream pressure acting against the piston is sufficient to overcome the spring force and fuel flow stream pressure so that sump fuel is returned into the original fuel flow stream.

14. A fuel delivery management system for management of fuel transfer during fueling of aircraft, having a single pressure sensor for the control of fueling flow rate and for control of fueling pressure, comprising:
a) a venturi that is placed in a fuel flow stream to create a single pressure sensing feedback signal;
b) a primary valve placed in the fuel flow stream modulates the fueling pressure and the fueling flow in response from the single pressure sensing feedback signal;
c) multiple sources for providing a reference pressure source during normal fuel operations, comprising:
i) a first source is normal system fueling pressure;
ii) a second source is an accumulator that is charged from the normal system fueling pressure; and
iii) a third source is a hand pump that charges the accumulator;
d) separate multiple sources for providing a start up reference pressure source, comprising:
i) a first source is an accumulator that is charged from the normal system fueling pressure; and
ii) a second source is a hand pump that will charge the accumulator;
e) an automatic sump pump back system that uses normal system high pressure fuel to return sump fluid back into the system fluid, comprising:
i) a sump to contain accumulated, or sump fuel;
ii) a control valve placed in the fuel flow stream to stop flow of fuel;
iii) a pump back cylinder to collect accumulated fuel from the sump;
iv) a spring return piston in the pump back cylinder to create a suction using a spring force to pull some of the sump fuel into the cylinder when the fuel flow stream pressure is low and to push the sump fuel in the cylinder into the fuel flow stream down stream of the flow restriction element when the fuel flow stream pressure is high; and
v) a piston and rod area difference such that fuel flow stream pressure acting against the piston is sufficient to overcome the spring force and fuel flow stream pressure so that sump fuel is returned into the original fuel flow stream.
